(19) United States
(12) Patent Application Publication
(10) Pub. No.: US 2004/0108439 A1
(43) Pub. Date: Jun. 10, 2004

(54) Umbrella base having aluminum casing

(76) Inventor: Oliver Joen-An Ma, Arcadia, CA (US)

Correspondence Address: Raymond Sun, 12420 Woodhall Way, Tustin, CA, 92782, US

(21) Appl. No.: 10/310,344

(22) Filed: Dec. 5, 2002

(51) Int. Cl. F16M 13/00

(52) U.S. Cl. 248/519

(57) ABSTRACT

A patio umbrella base has a base housing having an aluminum upper wall configured to define an interior space. The umbrella base further includes at least one cast iron piece positioned inside the interior space, and an aluminum seal provided over the cast iron piece(s) and securing the cast iron piece(s) to the upper wall. The aluminum seal can be provided by pouring molten aluminum over the cast iron piece(s) in a manner which completely covers the cast iron piece(s).

### BACKGROUND OF THE INVENTION

1. Field of the Invention

The present invention relates to outdoor and patio umbrellas, and in particular, to an umbrella base that is encased by aluminum to prevent rust.

2. Description of the Prior Art

Outdoor and patio umbrellas (hereinafter referred to collectively as patio umbrellas) have become increasingly popular in recent years as people have found new and useful applications for them. For example, patio umbrellas have traditionally been used at patios and backyards of homes to provide shade from sunlight. Patio umbrellas have also been used extensively at swimming pools and other play or recreation facilities to provide shade. Recently, hotels (and in particular, resorts) and restaurants have been major purchasers of these umbrellas.

Given the wide variety of use that patio umbrellas can be put to, it is important that an umbrella base be capable of providing adequate support to the patio umbrella. Conventional umbrella bases are made from one or more pieces of cast iron because cast iron is relatively inexpensive when compared to other materials, and can impart significant weight to provide the necessary support. For example, a conventional cast iron base is usually provided with a weight of about fifty pounds.

Unfortunately, cast iron is susceptible to rust. Since patio umbrellas are used outdoors, the bases are exposed to water and the environment. After a period of time, the cast iron bases will rust, and may need to be replaced.

Thus, there remains a need for an umbrella base that overcomes the drawbacks set forth above.

### SUMMARY OF THE DISCLOSURE

It is an object of the present invention to provide an umbrella base for use in supporting a patio umbrella in which the weight of the umbrella base is sufficiently heavy to provide adequate support and stability.

It is another object of the present invention to provide an umbrella base for use in supporting a patio umbrella in which the umbrella base is provided in an inexpensive material.

It is yet another object of the present invention to provide an umbrella base for use in supporting a patio umbrella in which the material used for the umbrella base is rust-proof.

The objectives of the present invention are accomplished by providing a patio umbrella base having a base housing having an aluminum upper wall configured to define an interior space. The umbrella base further includes at least one cast iron piece positioned inside the interior space, and an aluminum seal provided over the cast iron piece(s) and securing the cast iron piece(s) to the upper wall. The aluminum seal can be provided by pouring molten aluminum over the cast iron piece(s) in a manner which completely covers the cast iron piece(s).

Thus, the present invention provides an umbrella base whose exterior surfaces are all made of aluminum (which is rust-proof but very light in weight), while utilizing the aluminum to completely cover one or more cast iron pieces that are positioned inside the base housing. As a result, the present invention combines the advantages of cast iron (the weight and lower cost) and aluminum (rust-proof) in building an inexpensive, rust-proof and stable umbrella base.

### BRIEF DESCRIPTION OF THE DRAWINGS

FIG. 1 is a perspective view of a conventional patio umbrella.

FIG. 2 is a cross-sectional view of an umbrella base according to one embodiment of the present invention.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims. In certain instances, detailed descriptions of well-known devices and mechanisms are omitted so as to not obscure the description of the present invention with unnecessary detail.

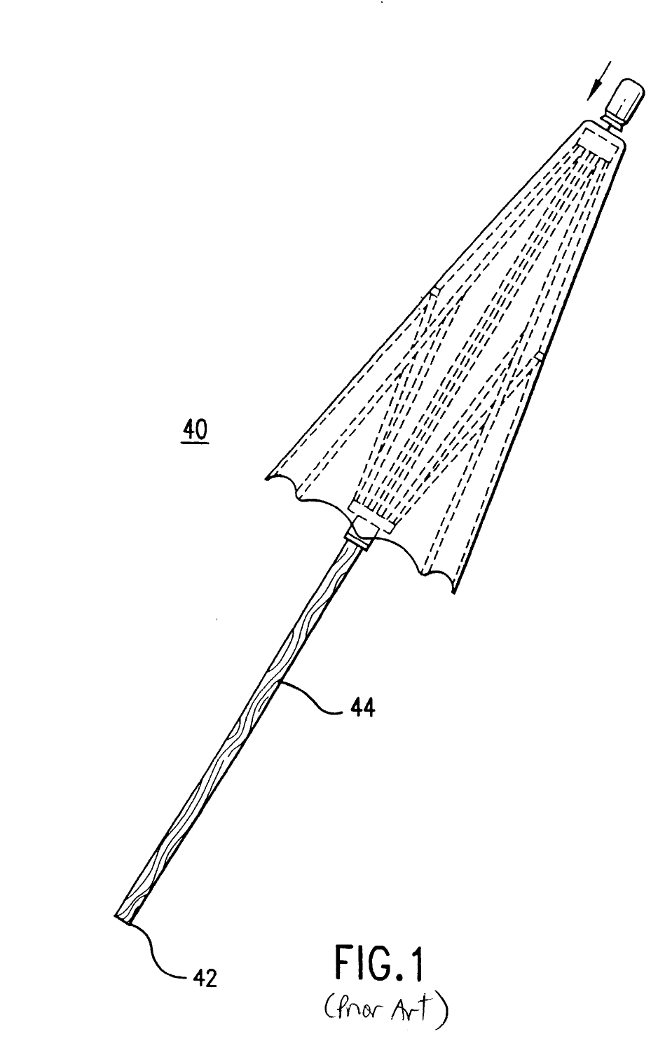

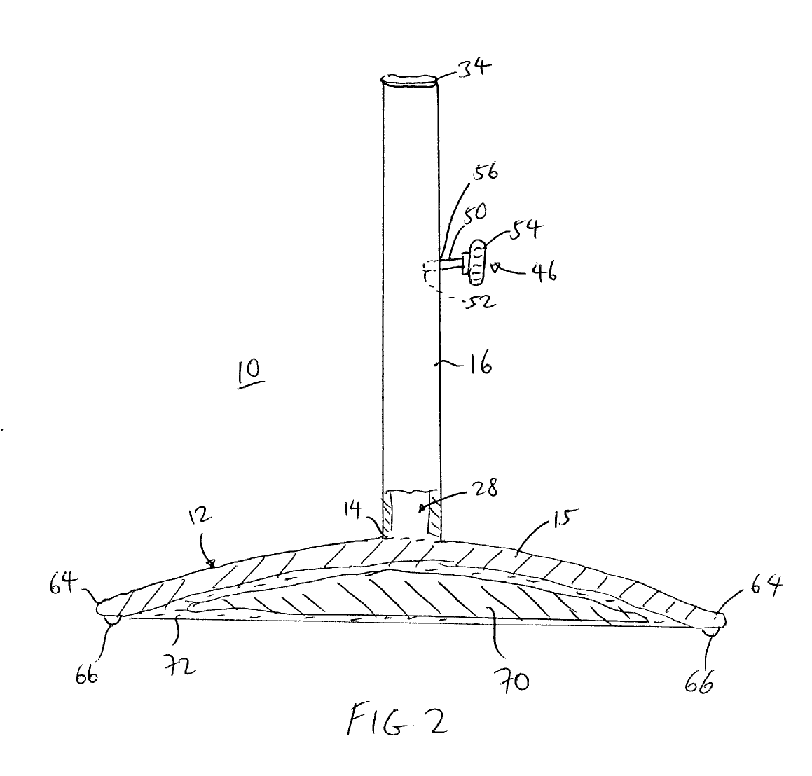

FIG. 2 illustrates an umbrella base 10 according to one embodiment of the present invention. The umbrella base 10 has a base housing 12 having a central opening 14 from which a cylindrical shaft 16 extends. The central opening 14 can be provided with internal threads that are adapted to threadably engage external threads provided at the bottom of the shaft 16, in a manner that is well-known in the art. The shaft 16 can be made from a metal material, such as aluminum. An annular ring 34 can be snap-fitted at the top of the shaft 16. The ring 34 is preferably made from plastic and has an annular lip that is intended to support the pole 44 of a patio umbrella 40 (see FIG. 1), and to prevent the metal material at the top of the second shaft 16 from abrasive contact with the wood pole 44. Therefore, the plastic ring 34 acts as a buffer that protects the wood pole 44 from abrasive rubbing against the metal material of the shaft 16, which can occur as the patio umbrella 40 sways from wind and other forces.

When the umbrella base 10 is to be used to hold and support a patio umbrella, such as a conventional patio umbrella 40 shown in FIG. 1, the bottom 42 of the pole 44 of the umbrella 40 is inserted into the shaft 16. The shaft 16 has a locking mechanism 46 that can be rotated to secure the pole 44 inside the bore 28 of the shaft 16. In a non-limiting embodiment of the present invention, the locking mechanism 46 can have a pin 50 having external threads 52 provided thereon, with a grip 54 provided at an end of the pin 50. Each pin 50 is threadably screwed inside an opening 56 in the shaft 16, with the pin 50 extending inside the bore 28 of the shaft 16 to push the pole 44 against the inner wall of the shaft 16 to secure the pole 44 inside the bore 28 of the shaft 16.

The base housing 12 has a dome-shaped upper wall 15 extending radially from a highest vertical elevation at the central opening 14 to the peripheral or circumferential edge 64 which is adapted to be positioned on the ground. A plurality of optional mini-bumps or rubber foots 66 can be spaced apart along the circumferential edge 64 to contact the ground, thereby raising the circumferential edge 64 slightly off the ground. The base housing 12 is preferably made from cast aluminum. A cast iron piece 70 (which can be embodied in the form of a generally dome-shaped circular piece of cast iron) is provided inside the base housing 12. Cast iron is preferred because iron is both heavier and less expensive than aluminum, although aluminum is generally rust-proof. Aluminum 72 can be then used to seal the interior of the base housing 12 so that the cast iron piece 70 is completely protected by the aluminum base housing 12 and the aluminum seal 72. Since the cast iron piece 70 is not exposed to the outside environment, rust can be prevented, thereby extending the useful life of the umbrella base 10 without significantly increasing the cost or compromising the weight and stability of the umbrella base 10.

Although FIG. 2 illustrates the provision of one cast iron piece 70, it is possible to provide one or more cast iron pieces 70 that are positioned inside the base housing 12. U.S. Pat. No. 6,113,054 discloses how more than one cast iron piece can be secured inside a base housing, and entire disclosure of U.S. Pat. No. 6,113,054 is hereby incorporated by this reference as though set forth fully herein.

The umbrella base 12 can be made using the following method. First, the base housing 12 can be turned upside-down so that the domed-shaped upper wall 15 is now positioned like a bowl, and then the cast iron piece 70 is fitted inside the domed interior of the base housing 12. If more than one cast iron piece 70 is to be provided inside the base housing, such additional cast iron pieces 70 can be secured at this time using the techniques described in U.S. Pat. No. 6,113,054. Next, melted aluminum 72 is poured inside the domed interior of the base housing 12 so that the melted aluminum 72 will flow around the cast iron piece(s) 70 and form a seal that completely protects the cast iron piece(s) 70 from exposure to the outside environment. The melted aluminum 72 is then dried to form the finished umbrella base 12.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A patio umbrella base comprising:
a base housing having an aluminum upper wall configured to define an interior space that opens towards a bottom;
at least one cast iron piece positioned inside the interior space; and
an aluminum seal provided over the at least one cast iron piece and securing the at least one cast iron piece to the upper wall.

2. The base of claim 1, wherein the upper wall has an inverted bowl shape.

3. The base of claim 1, wherein the seal is positioned at the bottom of the base housing.

4. A method of making a patio umbrella base, comprising:
providing a base housing having an aluminum upper wall configured to define an interior space;
positioning at least one cast iron piece inside the interior space; and
pouring molten aluminum over the at least one cast iron piece in a manner which completely covers the at least one cast iron piece.

5. The method of claim 4, further including:
drying the molten aluminum to secure the least one cast iron piece to the upper wall.
